(19) United States
(12) Patent Application Publication
(10) Pub. No.: US 2024/0322674 A1
(43) Pub. Date: Sep. 26, 2024

(54) POWER CONTROL METHOD AND DEVICE FOR CONTROLLING HARMONIC COMPONENT MAGNITUDE

(71) Applicant: SAMSUNG ELECTRONICS CO., LTD., Suwon-si (KR)

(72) Inventors: Hyomin AHN, Suwon-si (KR); Youngjae PARK, Suwon-si (KR); Junghyun LEE, Suwon-si (KR); Taeho LEE, Suwon-si (KR); Jehyung CHO, Suwon-si (KR)

(21) Appl. No.: 18/731,957

(22) Filed: Jun. 3, 2024

Related U.S. Application Data
(63) Continuation of application No. PCT/KR2022/018311, filed on Nov. 18, 2022.

(30) Foreign Application Priority Data
Dec. 3, 2021 (KR) 10-2021-0172263

(51) Int. Cl. H02M 1/42; H02M 1/00; H02M 7/06

(52) U.S. Cl. CPC H02M 1/4291; H02M 1/0048; H02M 7/06

(57) ABSTRACT

A home appliance for controlling a harmonic magnitude includes a current sensor configured to detect an input current of a power source, and at least one processor, and the at least one processor is configured to obtain a harmonic component from the input current detected by the current sensor, determine a length of a non-conducting interval of a switch so that a magnitude of the obtained harmonic component is less than a predetermined harmonic reference value, and generate a current reference value corresponding to the determined length of the non-conducting interval.

### CROSS-REFERENCE TO RELATED APPLICATIONS

This application is a continuation application, claiming priority under § 365(c), of International Application No. PCT/KR2022/018311, filed on Nov. 18, 2022, which is based on and claims the benefit of Korean Patent Application No. 10-2021-0172263 filed on Dec. 3, 2021, in the Korean Intellectual Property Office, the disclosures of which are incorporated by reference herein in their entireties.

### TECHNICAL FIELD

Embodiments of the present disclosure relate to a partial switching method and device for improving the energy efficiency of a home appliance via a power factor correction (PFC) circuit.

### BACKGROUND ART

For all electrical appliances, including home appliances, it is advantageous in terms of power usage to reduce power loss and optimize power efficiency. It is also important for energy savings that electrical appliances operate at optimal power efficiency. Each country legislates labeling of energy consumption efficiency rating for each home appliance, and thus, manufacturers are heavily focusing on research and development to make their home appliances highly efficient. Consumers regard energy consumption efficiency ratings displayed on home appliances as an important factor in purchasing the same.

Home appliances may achieve energy savings by securing an off-switching interval or a partial switching operation of a switch in an inverter circuit or power factor controller connected to a load, but this increases harmonic components. In this case, an off-switching interval needs to be determined to provide a maximum possible energy efficiency while satisfying harmonics regulation or power factor regulation.

### DISCLOSURE

### Technical Solution

A home appliance for controlling a harmonic magnitude, according to an embodiment of the present disclosure, includes a current sensor configured to detect an input current of a power source, and at least one processor configured to: obtain a harmonic component from the input current detected by the current sensor, determine a length of a non-conducting interval of a switch so that a magnitude of the obtained harmonic component is less than a predetermined harmonic reference value, and generate a current reference value corresponding to the determined length of the non-conducting interval.

A method, performed by a home appliance, of controlling a harmonic magnitude, according to an embodiment of the present disclosure, may include detecting, by a current sensor of the home appliance, an input current of a power source; obtaining a harmonic component from the input current detected by the current sensor; determining a length of a non-conducting interval of a switch so that a magnitude of the obtained harmonic component is less than a predetermined harmonic reference value; and generating a current reference value corresponding to the determined length of the non-conducting interval.

### DESCRIPTION OF DRAWINGS

FIG. 1 is a circuit diagram of an electrical appliance including a power factor correction (PFC) circuit.

FIG. 2 is a circuit diagram and control block diagram of controlling harmonics, according to an embodiment of the present disclosure.

FIG. 3 illustrates a waveform of a current shape reference output reflecting a non-conducting interval, according to an embodiment of the present disclosure.

FIGS. 4A, 4B, and 4C illustrate PFC circuits according to an embodiment of the present disclosure.

FIG. 5 is a circuit diagram and control block diagram of controlling harmonics, according to an embodiment of the present disclosure.

FIG. 6 is a control block diagram for generating a current shape reference by controlling a third-order harmonic, according to an embodiment of the present disclosure.

FIGS. 7A and 7B are waveform diagrams illustrating an input current and a harmonic current, according to an embodiment of the present disclosure.

FIG. 8 is a control block diagram for generating a current shape reference by controlling a plurality of harmonics, according to an embodiment of the present disclosure.

FIGS. 9A and 9B illustrate current waveforms according to harmonic control, according to an embodiment of the present disclosure.

FIG. 10 is a control block diagram for generating a current shape reference by controlling a plurality of harmonics, according to an embodiment of the present disclosure.

FIG. 11 is a circuit diagram of an electrical appliance including an interleaved PFC circuit, according to an embodiment of the present disclosure.

FIG. 12 is a block diagram of a control device for an electrical appliance, according to an embodiment of the present disclosure.

FIG. 13 is a flowchart of a harmonic control method according to an embodiment of the present disclosure.

### MODE FOR INVENTION

Terms used in the present disclosure will now be briefly described, and then an embodiment of the present disclosure will be described in detail.

As the terms used herein, general terms that are currently widely used are selected by taking functions according to an embodiment of the present disclosure into account, but the terms may be changed according to the intention of one of ordinary skill in the art, precedent cases, advent of new technologies, or the like. Furthermore, specific terms may be arbitrarily selected by the applicant, and in this case, the meaning of the selected terms will be described in detail in the detailed description of an embodiment of the present disclosure. Thus, the terms used herein should be defined not by simple appellations thereof but based on the meaning of the terms together with the overall description of the present disclosure.

Throughout the present disclosure, when a part “includes” or “comprises” an element, unless there is a particular description contrary thereto, it is understood that the part may further include other elements, not excluding the other elements. Furthermore, terms such as “portion,” “module,” etc. used herein indicate a unit for processing at least one function or operation and may be embodied as hardware or software or a combination of hardware and software.

An embodiment of the present disclosure will now be described more fully hereinafter with reference to the accompanying drawings so that the embodiment be easily implemented by one of ordinary skill in the art. However, an embodiment of the present disclosure may be implemented in different forms and should not be construed as being limited to an embodiment set forth herein. In addition, parts not related to descriptions of the present disclosure are omitted to clearly explain the present disclosure in the drawings, and like reference numerals denote like elements throughout.

According to an embodiment of the present disclosure, operating losses of an electrical appliance may be minimized by extracting magnitudes of harmonic components in real time from a grid (e.g., a power source) including the electrical appliance, controlling them via a controller to satisfy predetermined standard values, and calculating a length of a non-conducting interval of a switch in a power factor correction (PFC) circuit.

A home appliance for controlling a harmonic magnitude, according to an embodiment of the present disclosure, includes a current sensor configured to detect an input current of a power source, and at least one processor configured to obtain a harmonic component from the input current detected by the current sensor,
determine a length of a non-conducting interval of a switch so that a magnitude of the obtained harmonic component is less than a predetermined harmonic reference value, and generate a current reference value corresponding to the determined length of the non-conducting (non-switching) interval.

According to an embodiment of the present disclosure, the home appliance for controlling a harmonic magnitude may further include a rectifier configured to rectify the input current of the power source and a direct current (DC) link capacitor configured to smooth a DC voltage output from the rectifier, wherein a magnitude of a DC voltage across the DC link capacitor is greater than a magnitude of an input voltage of the power source.

According to an embodiment of the present disclosure, the home appliance for controlling a harmonic magnitude may further include a voltage sensor configured to detect the magnitude of the DC voltage across the DC link capacitor, and the generating of the current reference value corresponding to the determined length of the non-switching interval may include inputting, to a voltage controller, by the at least one processor, a result of comparing the magnitude of the DC voltage detected via the voltage sensor with a DC link voltage reference, inputting, to the current controller, an output of the voltage controller, the length of the non-switching interval, and the input current obtained from the current sensor, and outputting the current reference value from the current controller.

According to an embodiment of the present disclosure, the at least one processor may be further configured to generate a pulse width modulation (PWM) switching signal based on the current reference value.

According to an embodiment of the present disclosure, the home appliance for controlling a harmonic magnitude may further include a power factor correction (PFC) converter having a plurality of legs in parallel with the DC link capacitor, and the at least one processor may be further configured to randomly select at least one of the plurality of legs, and turn on and off a switch included in the randomly selected at least one leg via the PWM switching signal.

According to an embodiment of the present disclosure, the home appliance for controlling a harmonic magnitude may further include a PFC converter having a plurality of legs in parallel with the DC link capacitor, and the at least one processor may be further configured to sequentially select the plurality of legs, and turn on and off a switch included in at least one leg selected from among the plurality of legs via the PWM switching signal.

According to an embodiment of the present disclosure, the determining, by the at least one processor, of the length of the non-conducting interval of the switch may include performing, by the at least one processor, control to decrease the length of the non-conducting interval when the magnitude of the obtained harmonic component is greater than the predetermined harmonic reference value and increase the length of the non-conducting interval when the magnitude of the obtained harmonic component is less than the predetermined harmonic reference value.

According to an embodiment of the present disclosure, the obtained harmonic component may be third-order, fifth-order, . . . , and Nth-order harmonics where N is an odd integer greater than or equal to 7, and the determining, by the at least one processor, of the length of the non-conducting interval of the switch may include determining, by the at least one processor, a minimum value among an output of a third harmonic magnitude controller taking as an input a difference between the third-order harmonic and a third harmonic reference value, an output of a fifth harmonic magnitude controller taking as an input a difference between the fifth-order harmonic and a fifth harmonic reference value, . . . , and an output of an Nth harmonic magnitude controller taking as an input a difference between the Nth-order harmonic and an Nth harmonic reference value, and determining the length of the non-conducting interval based on the minimum value.

According to an embodiment of the present disclosure, the obtained harmonic component may be a third-order harmonic component and an Nth-order harmonic component where N is an odd integer greater than or equal to 5, and the determining, by the at least one processor, of the length of the non-conducting interval of the switch may include, when a magnitude of the Nth-order harmonic component is less than a predetermined Nth harmonic reference value, determining, by the at least one processor, the length of the non-conducting interval based on a result of subtracting a magnitude of the third-order harmonic component from a predetermined third harmonic reference value.

According to an embodiment of the present disclosure, the obtained harmonic component may be the third-order harmonic component and the Nth-order harmonic component where N is an odd integer greater than or equal to 5, and the determining, by the at least one processor, of the length of the non-conducting interval of the switch may include, when the magnitude of the Nth-order harmonic component is greater than the predetermined Nth harmonic reference value, subtracting, by the at least one processor, from the predetermined third harmonic reference value, an output value of a controller that takes as an input a result of subtracting the magnitude of the Nth-order harmonic component from the predetermined Nth harmonic reference value, and determining the length of the non-conducting interval based on a result of subtracting the magnitude of the third-order harmonic component from the third harmonic reference value that is the result of the subtraction.

According to an embodiment of the present disclosure, the determining, by the at least one processor, of the length of the non-conducting interval of the switch may include determining, by the at least one processor, the length of the non-conducting interval, based on an output value for controlling the magnitude of the obtained harmonic component to be less than the predetermined harmonic reference value and a phase difference between the input voltage and the input current of the power source.

According to an embodiment of the present disclosure, the generating, by the at least one processor, of the current reference value corresponding to the determined length of the non-conducting interval may include outputting, by the at least one processor, a current shape reference value corresponding to the current reference value, based on the determined length of the non-switching interval and the phase difference between the input voltage and the input current of the power source.

According to an embodiment of the present disclosure, the home appliance for controlling a harmonic magnitude may further include an output current sensor configured to detect an output current supplied to a load, and the determining, by the at least one processor, of the length of the non-conducting interval of the switch may include determining, by the at least one processor, the length of the non-conducting interval based on a variation in the output current supplied to the load.

According to an embodiment of the present disclosure, the at least one processor may be further configured to perform control so that the magnitude of the obtained harmonic component is less than the predetermined harmonic reference value and the length of the non-conducting interval of the switch is maximized.

A method, performed by a home appliance, of controlling a harmonic magnitude, according to an embodiment of the present disclosure, may include detecting, by a current sensor of the home appliance, an input current of a power source, obtaining a harmonic component from the input current detected by the current sensor, determining a length of a non-conducting interval of a switch so that a magnitude of the obtained harmonic component is less than a predetermined harmonic reference value, and generating a current reference value corresponding to the determined length of the non-conducting interval.

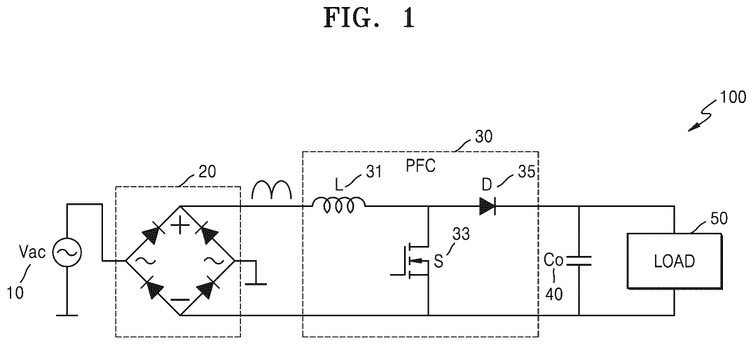

FIG. 1 is a circuit diagram of an electrical appliance including a PFC circuit.

FIG. 1 shows a power system 100 including the electrical appliance. The electrical appliance includes an alternating current (AC) input power source 10, a rectifier 20, a PFC circuit 30, a direct current (DC)-link capacitor 40, and a load 50. The PFC circuit 30 may include an inductor 31, a switch 33, and a diode 35. Increasing inductance of the inductor 31 in the PFC circuit 30 may reduce a surge current during a non-switching interval of the switch 33 but increase a size of a system. On the other hand, decreasing the inductance of the inductor 31 in the PFC circuit 30 may increase the surge current during the non-switching interval of the switch 33, and as a result, the electrical appliance may not meet the harmonics standard. Therefore, active control of the PFC circuit 30 (e.g., via a harmonic controller) is required to satisfy the harmonics standard while reducing the inductance of the inductor 31.

According to an embodiment, the PFC circuit 30 may generally include the rectifier 20, but the rectifier 20 is shown separately in FIG. 1.

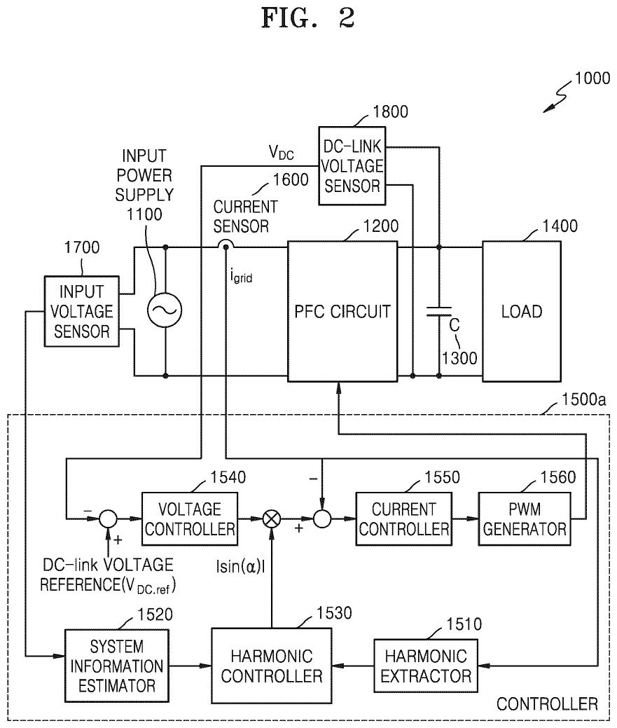

FIG. 2 is a circuit diagram and control block diagram of controlling harmonics, according to an embodiment of the present disclosure.

Referring to FIG. 2, an electrical appliance 1000 including harmonic control may be a home appliance or consumer electronic device, but is not limited thereto. According to an embodiment of the present disclosure, the electrical appliance 1000 according to FIG. 2 may be a power control device. According to an embodiment of the present disclosure, the electrical appliance 1000 according to FIG. 2 may be applied not only to an air conditioner and/or an outdoor unit of the air conditioner, but also to a server power supply and a slow charger for an electric vehicle. According to an embodiment of the present disclosure, the electrical appliance 1000 according to FIG. 2 may be used to drive a motor in a main body or an outdoor unit of an air conditioner, and a motor used in the outdoor unit of the air conditioner may be a compressor motor that circulates refrigerant in the outdoor unit of the air conditioner. Therefore, according to an embodiment of the present disclosure, the circuit in the electrical appliance 1000 may be a circuit used in the air conditioner.

Furthermore, the electrical appliance 1000 according to FIG. 2 may include, but is not limited to, an air conditioner, a washing machine, a dryer, a lamp, a TV, a heating device, a styler, etc. Heating devices may include, but are not limited to, a smart kettle, a teapot, a coffee pot, an induction device, a toaster, an air fryer, a highlight induction machine, a rice cooker, etc.

All of the components of the electrical appliance 1000 according to FIG. 2 are not essential components. The electrical appliance 1000 may be implemented with more or fewer components than those shown in FIG. 2. Throughout the specification, the electrical appliance 1000 may be referred to as a consumer electronic device, a home appliance, a cooking appliance, or a power control device, and these terms may be used interchangeably or substituted for one another. In addition, throughout the specification, the electrical appliance 1000 may be a consumer electronic device sold independently, or a device that constitutes a part of the consumer electronic device.

Each of the components of the electrical appliance 1000 will be described hereinafter.

According to an embodiment, an input power supply 1100 may be an AC power source via a power line connected to a power outlet. According to an embodiment, the input power supply 1100 may be a receiving device that wirelessly receives AC power from a station (not shown) according to wireless power transfer.

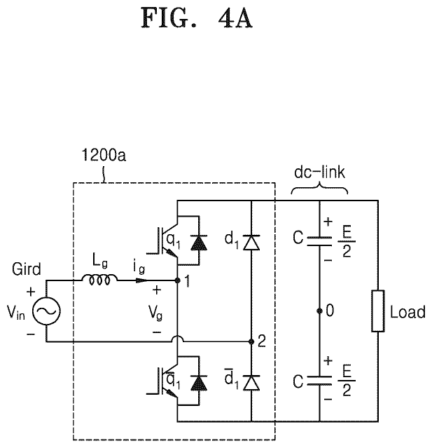

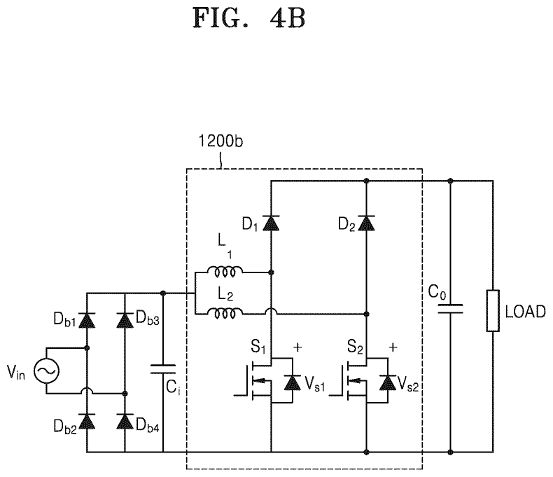

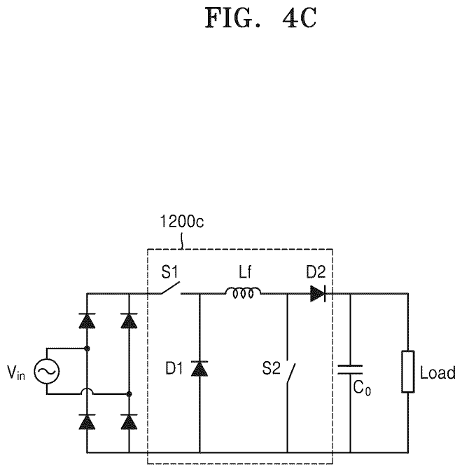

An input voltage sensor 1700 senses a voltage of the input power supply 1100 and transmits the sensed voltage information as an input to a power factor correction (PFC) controller, e.g., controller 1500a. A current sensor 1600 senses a current from the input power supply and transmits the sensed current information as an input to the controller 1500a. According to an embodiment of the disclosure, the current sensor 1600 may be placed between the input power supply and a PFC circuit 1200. According to an embodiment of the disclosure, the current sensor 1600 may be placed between a rectifier circuit which may be included in the PFC circuit and a DC-link capacitor 1300. In this case, the rectified current will be sensed for controlling harmonics. According to an embodiment of the disclosure, the current sensor 1600 may be placed to sense a current flowing through an inductor(s) which is illustrated referring to FIGS. 4A to 4C.

According to an embodiment, the PFC circuit 1200 according to FIG. 2 includes a rectifier circuit. A detailed circuit of the PFC circuit 1200 may be the circuit according to FIG. 1, and an additional circuit will be described further with reference to FIGS. 4A to 4C.

A voltage with harmonics controlled via the PFC circuit 1200 is smoothed by the DC-link capacitor 1300 and supplied to a load 1400. The voltage sensed by the input voltage sensor 1700, a DC-link voltage sensed by a DC-link voltage sensor 1800, and the current from the input power supply sensed by the current sensor 1600 are all used as inputs to the controller 1500a.

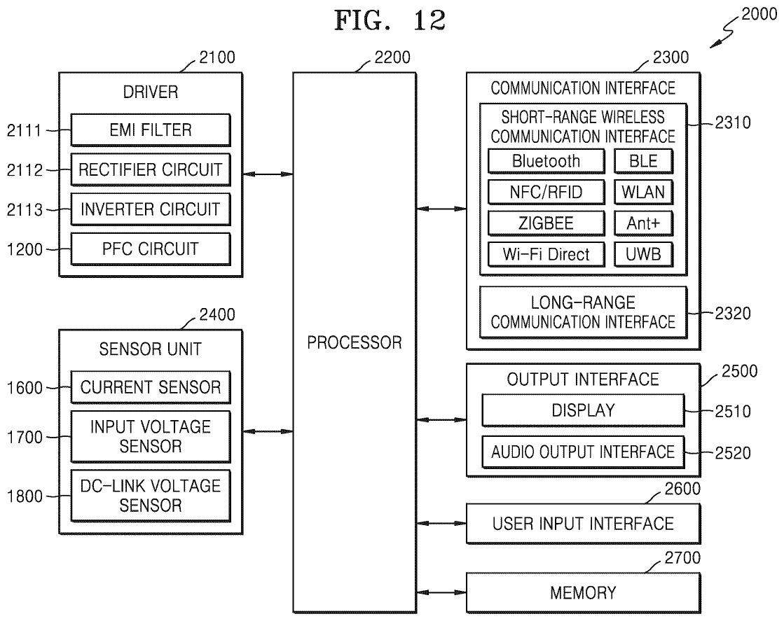

In an embodiment, the controller 1500a may be where control processing is performed by a processor (not shown) included in the electrical appliance 1000. A block diagram of a control device including the processor will be described again with reference to FIG. 12.

Hereinafter, an operation of the controller 1500a is described in detail.

A harmonic extractor 1510 extracts harmonic components from information about an input current i_{grid} (an input current from a power source or grid) sensed by the current sensor 1600. The processor or microprocessor controller (MICOM) is responsible for extracting harmonic components, and the harmonic components may be extracted using a fast Fourier transform (FFT) or a band pass filter. The types of harmonic components extracted vary depending on memory capacity and performance of the processor or MICOM included in the electrical appliance 1000. In an embodiment, if the memory capacity and the performance of the processor or MICOM are supported, the processor or MICOM may extract, from the input current from the power source, not only a third harmonic component but also higher frequency harmonic components (e.g., fifth, seventh, and ninth harmonic components). If the processor or MICOM extracts even the higher frequency harmonic components and performs harmonic control, a power factor of the entire power system including the electrical appliance 1000 may be improved more precisely. However, if the memory capacity and performance of the processor or MICOM are limited, the processor or MICOM extracts only the third harmonic component or the third and fifth harmonic components that have the greatest impact on total harmonic distortion (THD). Even when the processor or MICOM controls only a magnitude of the third harmonic component or the third and fifth harmonic components, the harmonic control and/or power factor improvement according to the present disclosure may be achieved.

A system information estimator 1520 receives, from the input voltage sensor 1700, voltage information obtained by sensing a voltage of the input power supply 1100. A harmonic controller 1530 may basically receive current information of the input power supply 1100 sensed by the current sensor 1600, harmonic components extracted by the harmonic extractor 1510, and voltage information of the input power supply 1100 from the system information estimator 1520 to determine a phase difference between an input voltage and an input current and determine magnitudes of the harmonic components.

If the harmonic controller 1530 determines that the magnitudes of the harmonic components do not meet the standard because the magnitudes of the harmonic component are greater than predetermined standard values, the harmonic controller 1530 performs control to output a control value to reduce a length δ of a non-conducting interval (a length of a non-switching interval) of a switch included in the PFC circuit 1200.

On the other hand, if the magnitudes of the harmonic components meet the standard, the harmonic controller 1530 performs control to output a control value to increase the length δ of the non-conducting interval (the non-conducting interval value or the non-switching interval length) of the switch included in the PFC circuit 1200. Throughout the specification, it is noted that a predetermined standard value may be used interchangeably with a ‘predetermined reference value’, and a predetermined harmonic standard value may be used interchangeably with the same meaning as a predetermined harmonic reference value. In addition, throughout the specification, a ‘non-conducting interval of a switch’ may be used interchangeably with a ‘non-switching interval’, and both are considered to have the same meaning.

Standards for harmonic components vary by country and power level. Therefore, depending on an individual country and a power level, the harmonic controller 1530 may predetermine a harmonic standard amount in comparison with an input harmonic component and store it in an internal memory. For example, IEEE standard 519-2014 defines the following THD limits.

TABLE 1

| | Individual | Total harmonic |
|---|---|---|
| Bus voltage V at PCC* | Harmonics (%) | distortion THD (%) |
| V ≤ 1.0kV | 5.0 | 8.0 |
| 1.0 kV < V ≤ 69 kV | 3.0 | 5.0 |
| 69 kV < V ≤ 161 kV | 1.5 | 2.5 |
| 161 kV < V | 1.0 | 1.5 ** |

*PCC: Point of common coupling
** High voltage systems are allowed up to 2.0% THD.

In an embodiment, the harmonic controller 1530 outputs a current shape reference ref(θ, δ)=|sin α|, based on the length δ of the non-conducting interval of the switch and phase information θ of a voltage determined through the voltage information of the input power supply 1100. The current shape reference ref(θ, δ)=|sin α| may be a phase reference that reflects the length of the non-conducting interval. The DC-link voltage sensor 1800 senses a voltage across the DC-link capacitor 1300, and the sensed voltage value across the DC-link capacitor 1300 is calculated with a DC-link voltage reference (calculation of a difference between the DC-link voltage reference and the voltage value across the DC-link capacitor) and input to a voltage controller 1540. An output of the voltage controller 1540 may be referred to as a current magnitude reference. The output current magnitude reference is input to the current controller 1550, together with an output |sin α| of the harmonic controller 1530 and the current information sensed by the current sensor 1600. The current controller 1550 calculates a final current reference value by multiplying the current magnitude reference by |sin α| which is the current phase and current shape reference, and a pulse width modulation (PWM) generator 1560 outputs a gate signal for control of the switch in the PFC circuit 1200. In an embodiment, in response to the operation of the controller 1500a, the PFC circuit 1200 outputs a current waveform according to the current shape reference |sin α| generated using Equation 1 below.

$$\begin{matrix}ref ( θ , detla ) = sin ( α ) = sin ( \frac{πθ}{π - 2 detla} - \frac{π}{2} ( \frac{π}{π - 2 δ} - 1 ) ) … θ > detla or θ < π - δ \\ ref ( θ , δ ) = sin ( α ) = sin ( \frac{π ( θ - π )}{π - 2 δ} - \frac{π}{2} ( \frac{π}{π - 2 δ} - 1 ) ) … θ > π + δ or θ < 2 π - δ \\ ref ( θ , δ ) - sin ( α ) = 0 , elsewise\end{matrix} \qquad [ Equation 1 ]$$

The generation of the current shape reference according to Equation 1 is merely an example, and a current shape reference may be generated by using other methods.

The generation of the current shape reference according to Equation 1 is merely an example, and the current shape reference may be generated using other methods.

In FIG. 2, the harmonic controller 1530, the voltage controller 1540, and the current controller 1550 may generally use a proportional integral (PI) controller, but are not limited thereto.

In an embodiment, in the operation of the electrical appliance 1000 controlled by the PFC circuit 1200 according to FIG. 2, a magnitude of a DC voltage across the DC-link capacitor 1300 is greater than a magnitude of the input voltage of the power source.

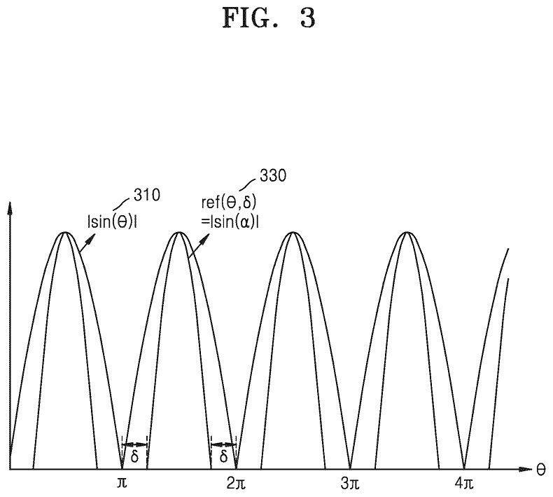

FIG. 3 illustrates a waveform of a current shape reference output reflecting a non-conducting interval, according to an embodiment of the present disclosure.

Referring to FIG. 3, a continuous sinusoidal current waveform |sin θ| 310 is shaped into a current waveform according to a current shape reference in a shape of |sin α| 330 as shown in FIG. 3 when a length δ of a non-conducting interval of a switch is determined. Given the current waveform, the waveform |sin α| 330 will have increased harmonic components than the waveform |sin θ| 310. If a harmonic component in the current waveform |sin α| 330 is larger than a predetermined harmonic standard value, the length δ of the non-conducting interval is reduced according to control by the electrical appliance 1000, and the waveform |sin α| 330 becomes closer to the waveform |sin θ| 310. On the other hand, if the harmonic component in the waveform |sin α| 330 is smaller than the predetermined harmonic standard value, the current waveform |sin α| 330 may be determined so that the length δ of the non-conducting interval of the switch becomes larger.

FIGS. 4A, 4B, and 4C illustrate PFC circuits according to an embodiment of the present disclosure.

A more detailed view of the PFC circuit 1200 of FIG. 2 is shown as blocks represented by dashed lines in FIGS. 4A, 4B, and 4C. The PFC circuits of FIGS. 4A, 4B, and 4C are merely an example, and various PFC circuits, including a basic bridgeless PFC circuit and a semi-bridgeless PFC circuit, may replace a block of the PFC circuit 1200 of FIG. 2.

FIG. 4A shows a totem-pole bridgeless PFC circuit. A block 1200a of FIG. 4A may replace the PFC circuit 1200 of FIG. 2. As shown in FIG. 4A, the totem-pole bridgeless PFC circuit has a switching element in one leg and a low-frequency diode in the other leg. Accordingly, a common mode voltage has a zero potential when an AC input voltage is positive (+), and a DC-link voltage when an AC input power is negative (−). Therefore, because the common mode voltage appears as a square wave voltage of 60 Hz, common mode noise characteristics may be improved by adopting the totem-pole bridgeless PFC circuit.

FIG. 4B shows an interleaved boost PFC circuit according to an embodiment of the present disclosure.

In an interleaved boost PFC circuit, when the controller controls inductor currents of two phases to have a phase difference of 180 degrees so that a leg with a switching element S1 and a leg with a switching element S2 do not overlap each other, both an input current ripple and an output current ripple may be reduced. As a result, the electrical appliance 1000 employing an interleaved boost PFC circuit may use a small-size electromagnetic interference filter and accordingly reduce material costs.

FIG. 4C shows a buck PFC circuit according to an embodiment of the present disclosure. Unlike the boost PFC circuit, the buck PFC circuit is used when an input voltage is higher than a target voltage established by the DC-link.

According to an embodiment of the present disclosure, the PFC circuit 30 according to FIG. 1 may also replace the PFC circuit 1200 of FIG. 2 as a boost PFC circuit.

The PFC circuits employing harmonic control according to the present disclosure are not limited to those shown in FIGS. 4A, 4B, and 4C, and various PFC circuits may be used.

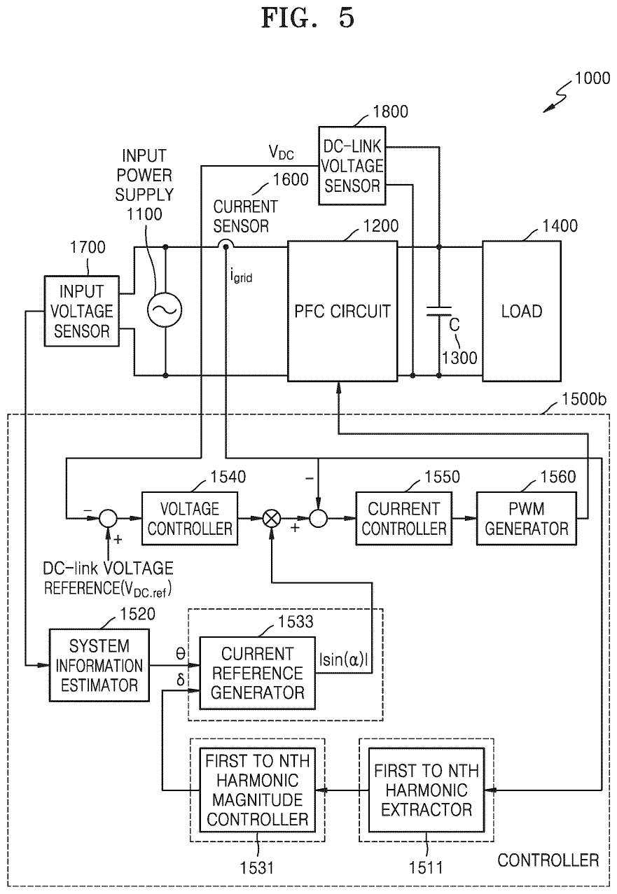

FIG. 5 is a circuit diagram and control block diagram of controlling harmonics, according to an embodiment of the present disclosure.

Referring to FIG. 5, like in FIG. 2, an electrical appliance 1000 including harmonic control may be a home appliance, but is not limited thereto. According to an embodiment of the present disclosure, the electrical appliance 1000 may be a power control device. According to an embodiment of the present disclosure, the electrical appliance 1000 according to FIG. 2 may be applied not only to an air conditioner and/or an outdoor unit of the air conditioner, but also to a server power supply and a slow charger for an electric vehicle. Furthermore, the electrical appliance 1000 according to FIG. 5 may include, but is not limited to, an air conditioner, a washing machine, a dryer, a lamp, a TV, a heating device, a styler, etc. Heating devices may include, but are not limited to, a smart kettle, a teapot, a coffee pot, an induction device, a toaster, an air fryer, a highlight induction machine, a rice cooker, etc.

All of the components of the electrical appliance 1000 according to FIG. 5 are not essential components. The electrical appliance 1000 may be implemented with more or fewer components than those shown in FIG. 5.

Each of the components of the electrical appliance 1000 will be described hereinafter.

According to an embodiment, the input power supply 1100 may be an AC power source via a power line connected to a power outlet. According to an embodiment, the input power supply 1100 may be an AC power source that receives AC power supplied from a station (not shown) according to wireless power transfer.

The block diagram of a controller 1500b according to FIG. 5 is a block diagram in which harmonic extraction and magnitude control are subdivided in detail compared to the block diagram of the controller 1500a according to FIG. 2. Therefore, because a circuit operation illustrated in FIG. 5 may be considered to be generally the same as the circuit operation of FIG. 2, description of the circuit operation overlapping with that of FIG. 2 will be omitted herein.

In FIG. 5, a voltage sensed by the input voltage sensor 1700, a DC-link voltage sensed by the DC-link voltage sensor 1800, and a current from the input power supply sensed by the current sensor 1600 are all used as inputs to the controller 1500b.

In an embodiment, the controller 1500b may be where control processing is performed by a processor (not shown) provided in the electrical appliance 1000. The block diagram including the processor will be described again with reference to FIG. 12.

Hereinafter, an operation of the controller 1500b is described in detail.

A first to Nth harmonic extractor 1511 extracts first to Nth-order harmonic components from the current information sensed by the current sensor 1600. Here, N is an odd integer greater than or equal to 3. The processor or MICOM may extract harmonic components by using a fast Fourier transform (FFT) or a band pass filter.

A system information estimator 1520 receives, from the input voltage sensor 1700, voltage information obtained by sensing a voltage of the input power supply 1100. The controller 1500b according to FIG. 5 may basically receive current information of the input power supply 1100 sensed by the current sensor 1600, harmonic components extracted by the harmonic extractor 1510, and voltage information of the input power supply 1100 from the system information estimator 1520 to determine a phase difference between an input voltage and an input current and determine magnitudes of the harmonic components.

If it is determined that any one of the magnitudes of the first to Nth-order harmonic components does not meet the standard and that magnitudes of harmonic components are greater than standard values, the first to Nth harmonic magnitude controller 1531 performs control to reduce a length δ of a non-conducting interval of the switch included in the PFC circuit 1200. For example, if the third-order harmonic component satisfies a predetermined standard value, but the fifth-order harmonic component does not satisfy a predetermined standard value, the first to Nth harmonic magnitude controller 1531 performs control to reduce the length δ of the non-conducting interval of the switch included in the PFC circuit 1200. Likewise, if the seventh-order harmonic component does not satisfy a predetermined standard value even though the third- and fifth-order harmonic components respectively satisfy the predetermined standard values, the first to Nth harmonic magnitude controller 1531 performs control to reduce the length δ of the non-conducting interval of the switch included in the PFC circuit 1200.

On the other hand, if it is determined that the magnitudes of the first to Nth-order harmonic components all meet predetermined standard values, the first to Nth harmonic magnitude controller 1531 increases the length δ of the non-conducting interval of the switch included in the PFC circuit 1200. For example, in an embodiment, it is assumed that N is set to 5 so that the electrical appliance 1000 controls only the third- and fifth-order harmonic components. When the first to Nth harmonic magnitude controller 1531 determines that the third- and fifth-order harmonic components satisfy the predetermined standard values without determining whether the seventh-order harmonic component satisfies the standard, the first to Nth harmonic magnitude controller 1531 increases the length δ of the non-conducting interval of the switch included in the PFC circuit 1200.

In an embodiment, a current reference generator 1533 outputs a current shape reference ref(θ, δ)=|sin α|, based on the length δ of the non-conducting interval, which is an output of the first to Nth harmonic magnitude controller 1531, and an input of phase information θ determined through the voltage information of the input power supply 1100. Here, the phase information θ may be information about a phase difference between a voltage of the input power supply 1100 and an input current. In an embodiment, the DC-link voltage sensor 1800 senses a voltage across the DC-link capacitor 1300, and the sensed voltage value across the DC-link capacitor 1300 is calculated with a DC-link voltage reference (calculation of a difference between the DC-link voltage reference and the voltage value across the DC-link capacitor 1300) and input to the voltage controller 1540. An output of the voltage controller 1540 is input to the current controller 1550, along with an output |sin α| of the harmonic controller 1530 and the current information sensed by the current sensor 1600. The current controller 1550 calculates a final current reference value, and the PWM generator 1560 outputs a gate signal for control of the switch in the PFC circuit 1200. In response to the operation of the controller 1500b, the PFC circuit 1200 outputs a current waveform according to the current shape reference |sin α| generated using Equation 1 above.

In FIG. 5, the voltage controller 1540, the current controller 1550, and the first to Nth harmonic magnitude controller 1531 may generally use a proportional integral (PI) controller, but is not limited thereto.

In an embodiment, in the operation of the electrical appliance 1000 controlled by the PFC circuit 1200 according to FIG. 5, a magnitude of a DC voltage across the DC-link capacitor 1300 is greater than a magnitude of the input voltage of the power source.

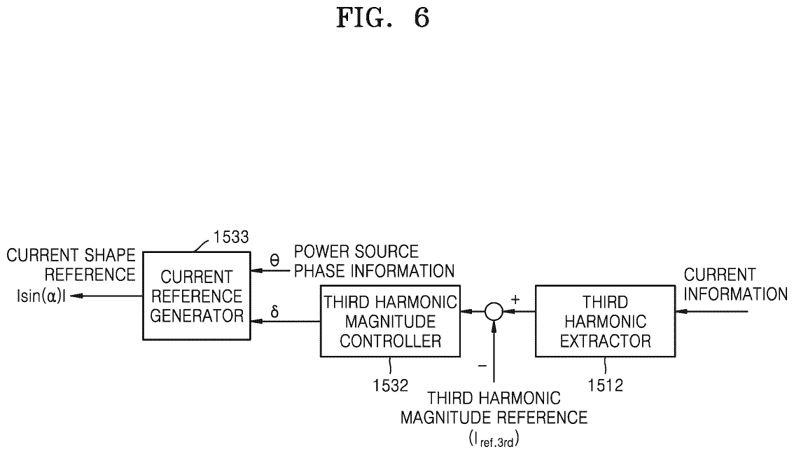

FIG. 6 is a control block diagram for generating a current shape reference by controlling a third-order harmonic, according to an embodiment of the present disclosure.

In an embodiment, in the control block diagram according to FIG. 6, a third harmonic extractor 1512 is used instead of the harmonic extractor 1510 of FIG. 2 or the first to Nth harmonic extractor 1511 of FIG. 5. In addition, in the control block diagram according to FIG. 6, a third harmonic magnitude controller 1532 is used instead of a portion of the harmonic controller 1530 of FIG. 2 and the first to Nth harmonic magnitude controller 1531 of FIG. 5.

According to an embodiment, the third harmonic extractor 1512 extracts a third-order harmonic component from the current information of the input power supply 1100 sensed by the current sensor 1600 of the electrical appliance 1000 (see FIG. 5). The third-order harmonic component of an input current, which is extracted by the third harmonic extractor 1512, is compared to a third harmonic magnitude reference, and a result of the comparison (subtraction) value is input to the third harmonic magnitude controller 1532. If the third harmonic magnitude controller 1532 determines that the magnitude of the third-order harmonic component does not meet the standard and is greater than a predetermined standard value, the third harmonic magnitude controller 1532 outputs a value δ (a non-switching interval length) for reducing a non-conducting interval of the switch included in the PFC circuit 1200.

On the other hand, if the third harmonic magnitude controller 1532 determines that the magnitude of the third-order harmonic component satisfies the predetermined standard value, the third harmonic magnitude controller 1532 increases the length δ of the non-conducting interval of the switch included in the PFC circuit 1200.

In an embodiment, the current reference generator 1533 outputs a current shape reference ref(θ, δ)=|sin α|, based on the length δ of the non-conducting interval, which is the output value of the third harmonic magnitude controller, and an input of the phase information θ determined through the voltage information of the input power supply 1100. According to the output current shape reference, the electrical appliance 1000 controls the switch element of the PFC circuit 1200 according to a gate signal generated by the PWM generator 1560.

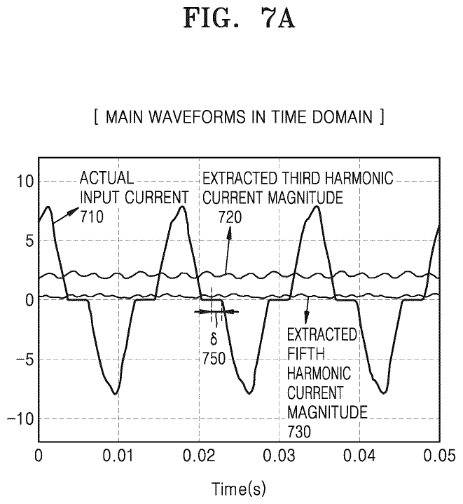

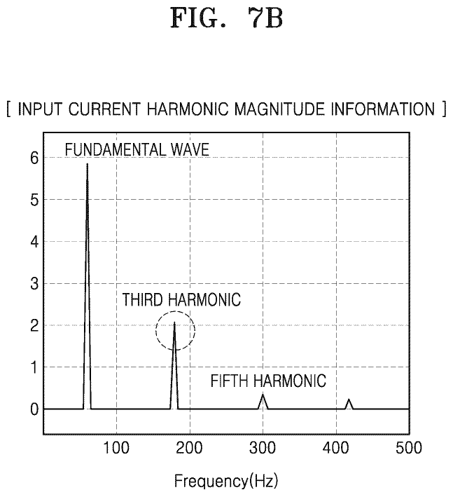

The third harmonic magnitude controller 1532 may be, but is not limited to, a PI controller. FIGS. 7A and 7B are waveform diagrams illustrating an input current from a power source and a harmonic current, according to an embodiment of the present disclosure.

According to FIG. 7A, an input current 710 has a sinusoidal wave shape with a non-conducting interval length δ 750. Referring to FIG. 7A, an extracted third harmonic current magnitude 720 and an extracted fifth harmonic current magnitude 730 are shown, which represent magnitudes of harmonic components extracted from the input current 710. When each of the third harmonic current magnitude 720 and the fifth harmonic current magnitude 730 is greater than a predetermined standard value, control for reducing the non-conducting interval length δ is performed by the controller 1500b, as shown in FIGS. 2 and 5. The input current 710 may be a grid current (input current from a power source) sensed by the current sensor 1600.

FIG. 7B illustrates an input current and harmonic currents represented at frequencies.

Referring to FIG. 7B, a fundamental wave of an input current is shown to have a magnitude of about 6 amperes (A).

Referring to FIG. 7B, a magnitude of a third-order harmonic component is shown to be about 2 A at 180 Hz which is the frequency of the third-order harmonic. If the current magnitude (about 2 A) is greater than a predetermined standard value, control is performed to reduce the non-conducting interval length δ of the switch.

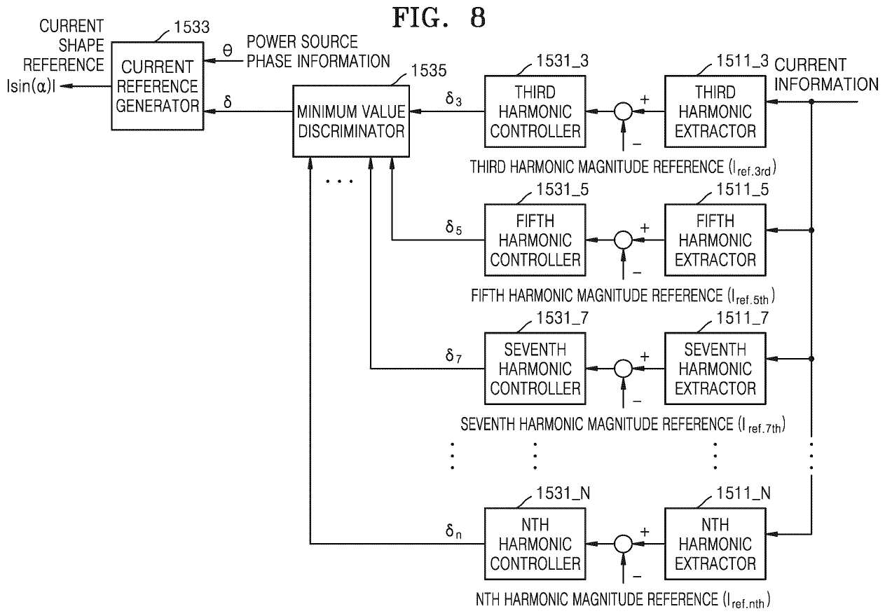

FIG. 8 is a control block diagram for generating a current shape reference by controlling a plurality of harmonics, according to an embodiment of the present disclosure.

Referring to FIG. 8, a third harmonic extractor 1511_3 extracts a third-order harmonic component from current information of the input power supply 1100 sensed by the current sensor 1600 of the electrical appliance 1000. A fifth harmonic extractor 1511_5 extracts a fifth-order harmonic component from the current information, a seventh harmonic extractor 1511_7 extracts a seventh-order harmonic component from the current information, and an Nth harmonic extractor 1511_N extracts an Nth-order harmonic component from the current information. Here, N is an odd integer greater than or equal to 9.

The third-order harmonic component of the input current extracted by the third harmonic extractor 1511_3 is compared with a third harmonic magnitude reference value, which is a predetermined standard value, and a result of the comparison (subtraction) is input to a third harmonic magnitude controller 1531_3. In an embodiment, if the third harmonic magnitude controller 1531_3 determines that a magnitude of the third-order harmonic component does not meet the standard and is greater than the predetermined standard value, the third harmonic magnitude controller 1531_3 performs control to reduce a non-conducting interval length 83 (a non-conducting interval length corresponding to the third-order harmonic component). Similarly, the fifth-order harmonic component of the input current extracted by the fifth harmonic extractor 1511_5 is compared with a fifth harmonic magnitude reference value, which is a predetermined standard value, and a result of the comparison (subtraction) is input to a fifth harmonic magnitude controller 1531_5. If the fifth harmonic magnitude controller 1531_5 determines that a magnitude of the fifth-order harmonic component does not meet the standard and is greater than a predetermined standard value, the fifth harmonic magnitude controller 1531_5 performs control to reduce a non-conducting interval length 85 (a non-conducting interval length corresponding to the fifth-order harmonic component). In the same manner, the seventh-order harmonic component of the input current extracted by the seventh harmonic extractor 1511_7 is compared with a seventh harmonic magnitude reference value, and a result of the comparison (subtraction) is input to a seventh harmonic magnitude controller 1531_7. If the seventh harmonic magnitude controller 1531_7 determines that a magnitude of the seventh-order harmonic component does not meet the standard and is greater than a predetermined standard value, the seventh harmonic magnitude controller 1531_7 performs control to reduce a non-conducting interval length 87 (a non-conducting interval length corresponding to the seventh-order harmonic component). Finally, the Nth-order harmonic component of the input current extracted by the Nth harmonic extractor 1511_N is compared with an Nth harmonic magnitude reference value, and a result of the comparison (subtraction) is input to an Nth harmonic magnitude controller 1531_N. If the Nth harmonic magnitude controller 1531_N determines that a magnitude of the Nth-order harmonic component does not meet the standard and is greater than a predetermined standard value, the Nth harmonic magnitude controller 1531_N performs control to reduce a non-conducting interval length δ_{N} (a non-conducting interval length corresponding to the Nth-order harmonic component). The non-conducting interval lengths δ₃, δ₅, δ₇, . . . , and ox respectively corresponding to the harmonic components are input to a minimum value determiner 1535, and the minimum value determiner 1535 selects a minimum value among the non-conducting interval lengths δ₃, δ₅, δ₇, . . . , and δ_{N} and transmits the minimum value as an input to a current reference generator 1533. The current reference generator 1533 outputs a current shape reference |sin α| based on the selected minimum value. In this way, the electrical appliance 1000 may determine a maximum non-switching interval in the PFC circuit 1200 while the plurality of harmonic components all meet the predetermined standard values.

For example, it is assumed that the third harmonic magnitude reference that is a predetermined standard value is 3 A, the fifth harmonic magnitude reference that is a predetermined standard value is 1 A, and the seventh harmonic magnitude reference that is a predetermined standard value is 0.3 A. If the magnitude of the fifth-order harmonic is 0.8 A, the magnitude of the seventh-order harmonic is 0.2 A, and the magnitude of the third-order harmonic is 4 A, then in the harmonic control according to FIG. 8, the third harmonic magnitude controller 1531_3 may output a smallest non-conducting interval length δ. The minimum value determiner 1535 transmits δ3 output from the third harmonic magnitude controller 1531_3 as an input of the current reference generator 1533.

It is also assumed that the third harmonic magnitude controller 1531_3 controls the magnitude of the third-order harmonic to be 2.5 A and at this time, the magnitude of the fifth-order harmonic is increased to 1.2 A. In this case, an output value δ₅ of the fifth harmonic magnitude controller 1531_5 may be the smallest compared to output values δ of the other harmonic magnitude controllers, and this value may be transmitted by the minimum value determiner 1535 as an input δ to the current reference generator 1533.

Harmonic extraction and harmonic magnitude control according to FIG. 8 is an embodiment, and the electrical appliance 1000 may extract harmonics up to the third- and fifth-order harmonics, and operate only up to the third and fifth harmonic magnitude controllers 1531_3 and 1531_5. In an embodiment, the electrical appliance 1000 may extract harmonics up to only the third-, fifth-, and seventh-order harmonics and operate only up to the third, fifth, and seventh harmonic magnitude controllers 1531_3, 1531_5, and 1531_7. In this way, the electrical appliance 1000 may select a harmonic extraction range according to the memory capacity and performance of the processor (or MICOM).

A harmonic magnitude controller corresponding to each harmonic component according to FIG. 8 may be a PI controller, but is not limited thereto.

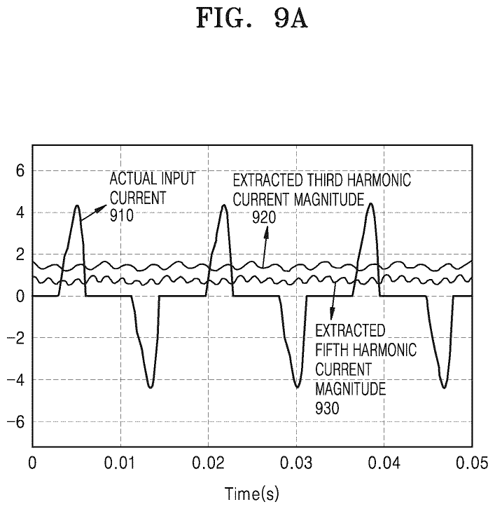

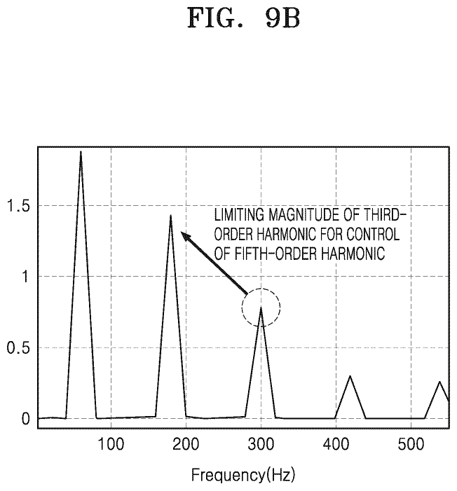

FIGS. 9A and 9B are waveform diagrams illustrating an actual input current and harmonic currents, according to an embodiment of the present disclosure.

Unlike in FIG. 7A, it can be seen in FIG. 9A that the overall magnitude of the harmonic components increases as a length of a non-conducting interval increases. Also, as seen from a fifth-order harmonic current magnitude 930, the magnitude of the fifth-order harmonic component has increased.

If a magnitude of a third-order harmonic component satisfies a predetermined standard value, but the magnitude of the fifth-order harmonic component does not satisfy a predetermined standard value, as described above with reference to FIG. 8, the electrical appliance 1000 may drive the PFC circuit 1200 by determining a minimum value among non-conducting interval length values δ₃, δ₅, δ₇, . . . , and δ_{N} of the switch output from the harmonic magnitude controllers for each harmonic order as a final non-conducting interval length value δ.

For example, in FIG. 9A, it is assumed that a predetermined standard value for the third-order harmonic is 2 A, and a predetermined standard value for the fifth-order harmonic is 0.5 A. In FIG. 9B, the magnitude of the third-order harmonic satisfies the predetermined standard value, but the magnitude of the fifth-order harmonic does not satisfy the predetermined standard value, so the relationship δ₅<δ₃ may be established. Therefore, the electrical appliance 1000 according to FIG. 8 may determine δ₅, which is less than δ₃, as a final non-conducting interval length.

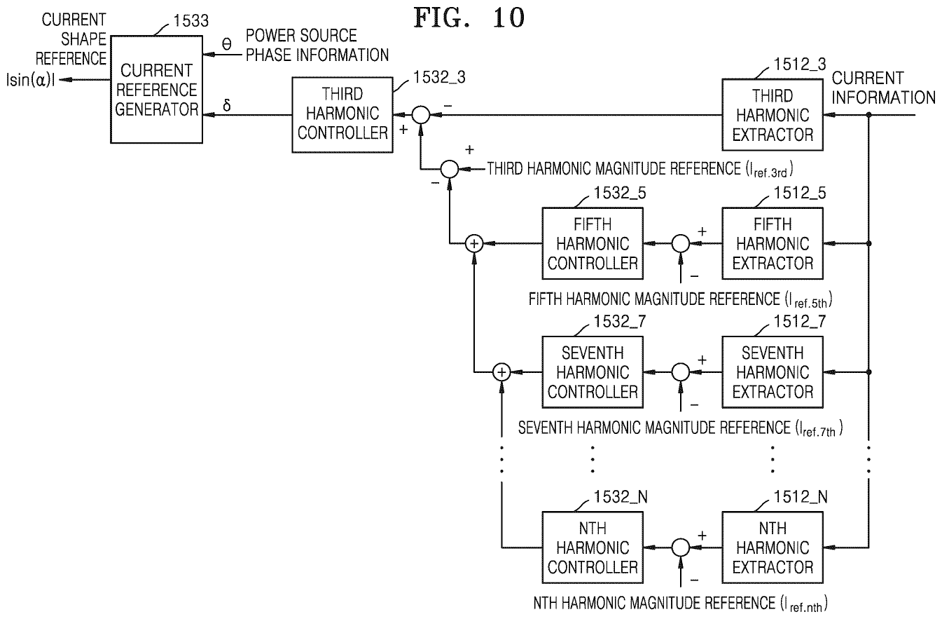

FIG. 10 is a control block diagram for generating a current shape reference by controlling a plurality of harmonics, according to an embodiment of the present disclosure.

Referring to FIG. 10, a third harmonic extractor 1512_3 extracts a third-order harmonic component from current information of the input power supply 1100 sensed by the current sensor 1600 of the electrical appliance 1000. A fifth harmonic extractor 1512_5 extracts a fifth-order harmonic component from the current information, a seventh harmonic extractor 1512_7 extracts a seventh-order harmonic component from the current information, and an Nth harmonic extractor 1512_N extracts an Nth-order harmonic component from the current information. Here, N is an odd integer greater than or equal to 9.

Harmonic control according to FIG. 10 is as follows.

First, it is assumed that a third harmonic magnitude reference corresponding to a predetermined standard value is 3 A, a fifth harmonic magnitude reference that is a predetermined standard value is 1 A, and a seventh harmonic magnitude reference that is a predetermined standard value is 0.3 A. If a magnitude of the fifth-order harmonic is 0.8 A, a magnitude of the seventh-order harmonic is 0.2 A, and a magnitude of the third-order harmonic is 4 A, then harmonic control according to FIG. 10 is performed only on the third-order harmonic. In FIG. 10, the controller operates only a third harmonic controller 1532_3 and the magnitude of the third-order is controlled to follow 3 A, which is the third harmonic magnitude reference, and accordingly, the third harmonic controller 1532_3 outputs a non-conducting interval length δ.

It is also assumed that the third harmonic controller 1532_3 controls the magnitude of the third-order harmonic to be 2.5 A and at this time, the magnitude of the fifth-order harmonic is increased to 1.2 A. Although the magnitude of the fifth-order harmonic needs to be reduced, according to an embodiment illustrated in FIG. 10, in this case, the electrical appliance 1000 controls the magnitude of the fifth-order harmonic by reducing the magnitude of the third-order harmonic via an output of the fifth harmonic controller rather than directly controlling the fifth-order harmonic. This is because the magnitude of the third-order harmonic is eventually correlated to the magnitude of the fifth-order harmonic. For example, by reducing the third harmonic magnitude reference from 3 A to 2.7 A, the overall magnitude of the fifth-order harmonic may also be reduced.

In this state, it is assumed that the third harmonic magnitude reference is lowered to 2.7 A, so the magnitude of the fifth-order harmonic is also reduced by the operation of the third harmonic controller 1532_3, and the magnitude of the seventh-order harmonic exceeds the predetermined standard value of 0.3 A and is increased to 0.5 A.

In this case, an output of the seventh harmonic controller 1532_7 is subtracted from the third harmonic magnitude reference value. That is, a processor 2200 of the electrical appliance 1000 controls the magnitude of the seventh-order harmonic by controlling the magnitude of the third-order harmonic in the same manner as it controls the magnitude of the fifth-order harmonic as described above. By reducing the third harmonic magnitude reference according to control by the processor 2200, the third harmonic controller 1532_3 follows the reduced third harmonic magnitude reference so that the magnitude of the seventh-order harmonic equals a predetermined standard value of 0.3 A.

Similarly, the Nth-order harmonic component of the input current extracted by the Nth harmonic extractor 1512_N is compared with an Nth harmonic magnitude reference that is predetermined standard value, and a result of the comparison (subtraction) is input to an Nth harmonic controller 1532_N. An output of the Nth harmonic controller 1532_N is subtracted from the third harmonic magnitude reference value.

In an embodiment, if none of the magnitude of the Nth-order harmonic, the magnitude of the seventh-order harmonic, and the magnitude of the fifth-order harmonic satisfies predetermined standard values, the output of the Nth harmonic controller 1532_N, the output of the seventh harmonic controller 1532_7, and the output of the fifth harmonic controller 1532_5 are all subtracted from the third harmonic magnitude reference value. The third harmonic magnitude reference value as a result of the subtraction is compared with the magnitude of the third-order harmonic extracted by the third harmonic extractor 1512_3 and is finally input to a PI controller that is the third harmonic controller 1532_3, and the third harmonic controller 1532_3 outputs a non-conducting interval length value.

As shown in FIG. 10, the output of the Nth harmonic controller 1532_N, the output of the seventh-order harmonic controller 1532_7, and the output of the fifth-order harmonic controller 1532_5 are added together and compared with the third harmonic magnitude reference, and a result of the comparison (subtraction) is compared with the magnitude of the third harmonic component of the input current extracted by the third harmonic extractor 1512_3 and input to the third harmonic controller 1532_3. The third harmonic controller 1532_3 reduces or increases a non-conducting interval length δ according to a result of the comparison.

The third harmonic controller 1532_3 transmits the non-conducting interval length δ as an input to the current reference generator 1533, and the current reference generator 1533 outputs a current shape reference |sin α|, based on the non-conducting interval length δ and phase information θ of the power source. By using this method, the electrical appliance 1000 may secure a maximum non-switching interval in the PFC circuit 1200 and reduce losses of the electrical appliance 1000 via PFC.

Harmonic extraction and harmonic magnitude control according to FIG. 10 is an embodiment, and like in an embodiment in which electrical appliance 1000 extracts harmonics up to the third- and fifth-order harmonics, and operates up to the third and fifth-harmonic controllers 1532_3 and 1532_5, an embodiment in which the electrical appliance 1000 extracts harmonics up to the third-, fifth-, and seventh-order harmonics and operates up to the third, fifth, and seventh harmonic controllers 1532_3, 1532_5, and 1532_7, etc., the electrical appliance 1000 may select various controller operations depending on the memory capacity and performance of the processor (or MICOM).

The third harmonic controller 1532_3 and the harmonic magnitude controller corresponding to each harmonic component may be a PI controller, but are not limited thereto.

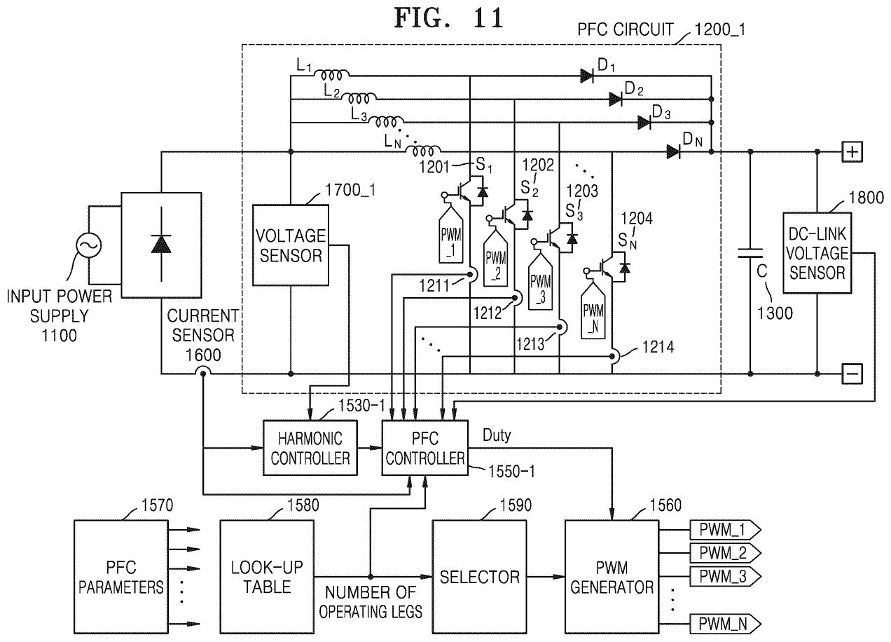

FIG. 11 is a circuit diagram of an electrical appliance including an interleaved PFC circuit, according to an embodiment of the present disclosure.

In general, converters and the electrical appliance 1000 including a PFC circuit have low efficiency at low loads. Therefore, in the electrical appliance 1000 or converter including the PFC circuit, energy efficiency may be increased by controlling the number of phases by employing a multi-phase interleaving technique.

Referring to FIG. 11, when there are multiple switching legs in an interleaved PFC circuit 1200_1, a phase shedding control technique in which only specific legs rather than all legs perform switching operations at a particular load region (usually a light load region) may be applied to improve the energy efficiency of the electrical appliance 1000.

A control operation performed by the harmonic controller 1530_1 of FIG. 11 is similar to the operations performed by the system information estimator 1520, the harmonic extractor 1510, and the harmonic controller 1530 of FIG. 2.

PFC parameters 1570 for loss measurement are key parameters for phase shedding control and include, but are not limited to, power source's output voltage, output current, switching frequency, input voltage, and input current. A block of a lookup table 1580 determines the number of switching legs based on input information about the PFC parameters 1570 information for loss measurement.

TABLE 2

| | | Number of operating legs | | | | |
|---|---|---|---|---|---|---|
| | | 1 EA | 2 EA | 3 EA | . . . | N EA |
| Grid | 1A | Loss information according to magnitude of | | | | |
| Current | 2A | input current and number of operating legs | | | | |
| | 3A | | | | | |
| | 4A | | | | | |
| | 5A | | | | | |
| | . | | | | | |
| | . | | | | | |
| | . | | | | | |
| | X A | | | | | |

Table 2 shows an exemplary lookup table 1580. In Table 2, when loss information according to a switching frequency compared to a grid current (input current) is measured, the number of operating legs may be determined according to the measured loss information. While loss information according to a magnitude of the input current and the number of operating legs is determined by the PFC parameters 1570 for loss measurement, the input current may be generally determined by the amount of load used by the electrical appliance 1000, and the number of legs for which losses are relatively small compared to the input current. The larger the number of legs, the smaller the losses are likely to be, but the manufacturer may limit the number of legs by taking into account the manufacturing cost of the electrical appliance 1000. In an embodiment, according to the number of legs determined via the lookup table 1580, a processor (not shown) selects a leg to operate via a selector 1590. Selection of a leg by the selector 1590 may be performed randomly or sequentially. The selector 1590 may select legs randomly or sequentially because if the processor does not select the legs randomly or sequentially during phase shedding control, lifespan deviations may occur across the legs.

The PWM generator 1560 takes as an input a switching-on duty of a leg switch (a conducting duty of the switch minus a non-conducting interval), which is an output of a PFC controller 1550_1, and a leg selected by the selector 1590, to generate a PWM signal, which is then used to transmit a gate signal to the switch of the leg.

FIG. 12 is a block diagram of a control device for an electrical appliance, according to an embodiment of the present disclosure.

The electrical appliance 1000 may include a control device 2000 that performs gate control of the PFC circuit 1200 and overall control of the controllers 1500a and 1500b, in addition to circuit diagrams of the power system according to FIGS. 2 and 5.

As shown in FIG. 12, according to an embodiment of the present disclosure, the control device 2000 may include a driving unit 2100, a processor 2200, a communication interface 2300, a sensor unit 2400, an output interface 2500, a user input interface 2600, and a memory 2700. Not all components of the control device 2000 are essential, and each component may be omitted or added depending on a design concept of the manufacturer.

The components are described in detail.

The driving unit 2100 may receive power from an external source (ES) and supply current to a load in response to a driving control signal from the processor 2200. The driving unit 2100 may include, but is not limited to, an electromagnetic interference (EMI) filter 2111, a rectifier circuit 2112, an inverter circuit 2113, and a PFC circuit 1200.

The EMI filter 2111 may block high-frequency noise included in AC power supplied from an ES and pass an AC voltage and an AC current of a predetermined frequency (e.g., 50 Hz or 60 Hz). A fuse and a relay may be provided between the EMI filter 2111 and the external power source (ES) to interrupt overcurrent. The AC power from which high-frequency noise is blocked by the EMI filter 2111 is supplied to the rectifier circuit 2112.

The rectifier circuit 2112 may convert AC power into DC power. For example, the rectifier circuit 2112 may convert an AC voltage whose magnitude and polarity (positive voltage or negative voltage) change over time into a DC voltage whose magnitude and polarity remains constant with time, and convert an AC current whose magnitude and direction (positive current or negative current) change with time into a DC current having a constant magnitude. The rectifier circuit 2112 may include a bridge diode. For example, the rectifier circuit 2112 may include four diodes. The bridge diode may convert an AC current whose polarity changes with time into a positive voltage having a constant polarity, and convert an AC current whose direction changes with time into a positive current having a constant direction.

The inverter circuit 2113 may include a switching circuit for supplying or blocking current to a load (not shown). The switching circuit may include a first switch and a second switch. The first switch and the second switch may be connected in series between a plus line and a minus line from the rectifier circuit 2112. The first switch and the second switch may be turned on or off in response to a driving control signal from the processor 2200.

The inverter circuit 2113 may control current supplied to the load. For example, a magnitude and a direction of the current flowing in the load may change according to turning on/off of the first switch and the second switch included in the inverter circuit 2113. In this case, an AC current may be supplied to the load. An AC current in the form of a sine wave is supplied to the load according to switching operations of the first switch and the second switch. Furthermore, the longer the switching period of the first switch and the second switch (e.g., the lower the switching frequency of the first switch and the second switch), the larger the current supplied to the load, and the greater the strength of a magnetic field (a power output of the control device 2000) output to the load. In FIG. 12, the inverter circuit 2113 may be required when supplying an AC current to the load, and thus may not be required in the electrical appliance 1000 that supplies a DC current to the load. In addition, according to an embodiment, the inverter circuit 2113 of the electrical appliance 1000 may be replaced with the PFC circuit 1200.

The processor 2200 controls all operations of the electrical appliance 1000. The processor 2200 may execute programs stored in the memory 2700 to control the driving unit 2100, the communication interface 2300, the sensor unit 2400, the output interface 2500, the user input interface 2600, and the memory 2700.

According to an embodiment of the present disclosure, the control device 2000 may be equipped with an artificial intelligence (AI) processor. The AI processor may be manufactured in the form of a dedicated hardware chip for AI, or manufactured as part of an existing general-purpose processor (e.g., a central processing unit (CPU) or an application processor (AP)) or a dedicated graphics processor (e.g., a graphics processing unit (GPU)) and mounted on the control device 2000.

According to an embodiment of the present disclosure, the processor 2200 may perform controller operations of the harmonic extractor, the harmonic controller, the current controller, and the voltage controller included in the controller 1500a or 1500b of the electrical appliance 1000. In this case, controllers for the harmonic controller, the current controller, and the voltage controller may be PI controllers, but are not limited thereto. Information about harmonic component standard values of the electrical appliance 1000 may be stored in the memory 2700 of the control device 2000.

The processor 2200 may include the communication interface 2300 to operate on an Internet of Things (IoT) network or a home network, as needed.

The communication interface 2300 may include a short-range communication interface 2310 and a long-range communication interface 2320. The short-range communication interface 2310 may include, but is not limited to, a Bluetooth communication interface, a Bluetooth Low Energy (BLE) communication interface, a Near Field Communication (NFC) interface, a wireless local area network (WLAN) (or Wi-Fi) communication interface, a ZigBee communication interface, an Infrared Data Association (IrDA) communication interface, a Wi-Fi Direct (WFD) communication interface, an ultra-wideband (UWB) communication interface, an Ant+ communication interface, etc. The long-range communication interface 2320 may be used to transmit or receive a wireless signal to or from at least one of a base station, an external terminal, and a server on a mobile communication network. In this case, the wireless signal may be a voice call signal, a video call signal, or data in any one of various formats according to transmission and reception of a text/multimedia message. The long-range communication interface 2320 may include, but is not limited to, a third-generation (3G) module, a fourth-generation (4G) module, a fifth-generation (5G) module, a long-term evolution (LTE) module, a narrowband IoT (NB-IoT) module, an LTE machine (LTE-M) module, etc.

According to an embodiment of the present disclosure, the electrical appliance 1000 may communicate with an external server or other electrical appliances and transmit and receive data via the communication interface 2300.

The sensor unit 2400 may include the current sensor 1600, the input voltage sensor 1700, and the DC-link voltage sensor 1800. The current sensor 1600 may sense an input current of the electrical appliance 1000. The current sensor 1600 may be placed at various locations in the circuit of the electrical appliance 1000 to obtain current (mainly AC) information. The input voltage sensor 1700 is used to sense voltage information of the input power supply 1100 of the electrical appliance 1000. The DC-link voltage sensor 1800 may be used as an input to the voltage controller 1540 by sensing a DC-link voltage.

The output interface 2500 is for outputting audio signals or video signals and may include a display 2510, an audio output unit 2520, etc.

According to an embodiment of the present disclosure, the control device 2000 may display information related to the electrical appliance 1000 on the display 2510. For example, the control device 2000 may display, on the display 2510, power factor information of the electrical appliance 1000 or values of each harmonic component (e.g., percentage (%) or A of each harmonic component relative to the input current).

When the display 2510 and a touch pad form a layered structure to construct a touch screen, the display 2510 may serve as an input device as well as an output device. The display may include at least one of a liquid crystal display (LCD), a thin-film transistor LCD (TFT-LCD), a light-emitting diode (LED) display, an organic LED (OLED) display, a flexible display, a three-dimensional (3D) display, and an electrophoretic display. Also, the control device 2000 may include two or more displays 2510 according to its implemented configuration.

The audio output interface 2520 may output audio data received from the communication interface 2300 or stored in the memory 2700. The audio output interface 2520 may output sound signals related to functions performed by the control device 2000. The audio output interface 2520 may include a speaker, a buzzer, etc.

According to an embodiment of the present disclosure, the output interface 2500 may output at least one of power factor information and harmonic component information via the display 2510. According to an embodiment of the present disclosure, the output interface 2500 may also display a current power level, an operating mode (e.g., low noise mode, normal mode, high power mode, etc.), a power factor control status, a current power factor, etc.

The user input interface 2600 is for receiving an input from a user. The user input interface 2600 may be at least one of a keypad, a dome switch, a touch pad (a capacitive overlay type, a resistive overlay type, an infrared beam type, a surface acoustic wave type, an integral strain gauge type, a piezoelectric type, etc.), a jog wheel, and a jog switch, but is not limited thereto.

The user input interface 2600 may include a speech recognition module. For example, the control device 2000 may receive a speech signal, which is an analog signal, via a microphone, and convert a part of speech into a computer-readable text by using an automatic speech recognition (ASR) model. The control device 2000 may obtain an intent in a user's utterance by interpreting the text using a natural language understanding (NLU) model. Here, the ASR model or NLU model may be an AI model. An AI model may be processed by a dedicated AI processor designed with a hardware structure specialized for processing an AI model. The AI model may be created via a training process. In this case, the creation via the training process means that predefined operation rules or AI model set to perform desired characteristics (or purposes) are created by training a basic AI model based on a large number of training data via a learning algorithm. The AI model may include of a plurality of neural network layers. Each of the plurality of neural network layers has a plurality of weight values and may perform neural network computations via calculations between a result of computations in a previous layer and the plurality of weight values.

Linguistic understanding is a technology for recognizing and applying/processing human language/characters and may include natural language processing, machine translation, a dialog system, question answering, speech recognition/synthesis, etc.

The memory 2700 may store programs necessary for processing and control by the processor 2200, and input/output data (e.g., power factor information of the electrical appliance 1000, information about harmonic components, etc.). The memory 2700 may store an AI model.

The memory 2700 may include at least one type of storage medium among a flash memory-type memory, a hard disk-type memory, a multimedia card micro-type memory, a card-type memory (e.g., an Secure Digital (SD) card or an Extreme Digital (XD) memory), random access memory (RAM), static RAM (SRAM), read-only memory (ROM), electrically erasable programmable ROM (EEPROM), PROM, a magnetic memory, a magnetic disc, and an optical disc. In addition, the control device 2000 may operate a web storage or cloud server that performs a storage function on the Internet.

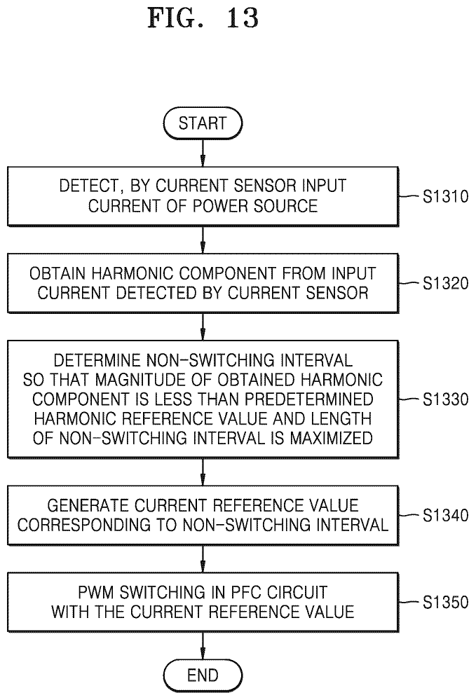

FIG. 13 is a flowchart of a harmonic control method according to an embodiment of the present disclosure.

In operation S1310, an input current of a power source is detected by the current sensor 1600 of the electrical appliance 1000.

In operation S1320, the processor 2200 obtains harmonic components from the input current detected by the current sensor 1600. To obtain harmonic components of each order, the processor 2200 may use a band pass filter or FFT. A harmonic component obtained to control the magnitude of harmonics may vary depending on the performance of the processor 2200 or capacity of the memory 2700 of the electrical appliance 1000, or user settings. That is, when speed of the entire system to which the electrical appliance 1000 belongs is increased or the capacity of the processor 2200 or memory 2700 is limited, the electrical appliance 1000 may extract only a third-order harmonic component and control only a magnitude of the third-order harmonic component. Alternatively, the electrical appliance 1000 may extract third- and fifth-order harmonics to control magnitudes of only the two harmonic components, or magnitudes of more harmonic components.

In operation S1330, the processor 2200 determines a non-switching interval length via the controller so that the harmonic component previously obtained is smaller than a predetermined harmonic reference value (predetermined standard value) and the non-switching interval (non-conducting interval of a switch) in the PFC circuit 1200 is maximized. An embodiment for determining the length of the non-switching interval (length of the non-conducting interval) has been described above in detail, and thus, descriptions already provided will be omitted here.

In operation S1340, the processor 2200 generates a current reference value corresponding to the determined non-switching interval. The current reference value may be a current shape reference value and have a shape like the waveform 330 in FIG. 3.

In operation S1350, when the current reference value is determined, the processor 2200 may generate a gate signal for controlling the switch in the PFC circuit 1200 via the PWM generator 1560.

A method according to an embodiment of the present disclosure may be implemented in the form of program commands executable by various types of computers and may be recorded on computer-readable recording media. The computer-readable recording media may include program commands, data files, data structures, etc. either alone or in combination. The program commands recorded on the computer-readable recording media may be designed and configured specially for the present disclosure or may be known to and be usable by a person of skill in the art of computer software. Examples of the computer-readable recording media include magnetic media such as hard disks, floppy disks, and magnetic tapes, optical media such as compact disk ROM (CD-ROM) and digital versatile disks (DVDs), magneto-optical media such as floptical disks, and hardware devices that are specially configured to store and perform program commands, such as ROM, RAM, flash memory, etc. Examples of program commands include not only machine code such as that created by a compiler but also high-level language code that may be executed by a computer using an interpreter or the like.

Some embodiments of the present disclosure may also be implemented in the form of recording media including instructions executable by a computer, such as a program module executed by the computer. The computer-readable recording media may be any available media that are accessible by a computer and include both volatile and nonvolatile media and both removable and non-removable media. Furthermore, the computer-readable recording media may include both computer storage media and communication media. The computer storage media include both volatile and nonvolatile, removable and non-removable media implemented using any method or technology for storage of information such as computer-readable instructions, data structures, program modules, or other data. The communication media typically embody computer-readable instructions, data structures, program modules, other data in a modulated data signal such as a carrier wave, or other transmission mechanism, and may include any information transmission media. Furthermore, some embodiments of the present disclosure may also be implemented as a computer program product or computer program including instructions executable by a computer, such as a computer program executable by the computer.

A machine-readable storage medium may be provided in the form of a non-transitory storage medium. In this regard, the term ‘non-transitory storage medium’ only means that the storage medium does not include a signal (e.g., electromagnetic wave) and is a tangible device, and the term does not differentiate between where data is semi-permanently stored in the storage medium and where the data is temporarily stored in the storage medium. For example, the ‘non-transitory storage medium’ may include a buffer for temporarily storing data.

According to an embodiment, methods according to various embodiments set forth in the present specification may be included in a computer program product when provided. The computer program product may be traded, as a product, between a seller and a buyer. The computer program product may be distributed in the form of a machine-readable storage medium (e.g., CD-ROM) or distributed (e.g., downloaded or uploaded) on-line via an application store or directly between two user devices (e.g., smartphones). For online distribution, at least a part of the computer program product (e.g., a downloadable app) may be at least transiently stored or temporally generated in the machine-readable storage medium such as a memory of a server of a manufacturer, a server of an application store, or a relay server.

1. A home appliance configured to control a harmonic magnitude, the home appliance comprising:
a current sensor configured to detect an input current from a power source; and
at least one processor configured to:
obtain a harmonic component from the input current detected by the current sensor,
determine a length of a non-conducting interval of a switch so that a magnitude of the obtained harmonic component is less than a predetermined harmonic reference value, and
generate a current reference value corresponding to the determined length of the non-conducting interval.

2. The home appliance of claim 1, further comprising:
a rectifier configured to rectify the input current of the power source; and
a direct current (DC) link capacitor configured to establish a DC voltage output from the rectifier,
wherein a magnitude of a DC voltage across the DC link capacitor is greater than a magnitude of an input voltage of the power source.

3. The home appliance of claim 2, further comprising
a voltage sensor configured to detect the magnitude of the DC voltage across the DC link capacitor,
wherein the generating of the current reference value corresponding to the determined length of the non-conducting interval comprises
inputting, to a voltage controller, by the at least one processor, a result of comparing the magnitude of the DC voltage detected via the voltage sensor with a DC link voltage reference, inputting, to a current controller, an output of the voltage controller, the length of the non-conducting interval, and the input current obtained from the current sensor, and outputting the current reference value from the current controller.

4. The home appliance of claim 1, wherein the at least one processor is further configured to generate a pulse width modulation (PWM) switching signal based on the current reference value.

5. The home appliance of claim 4, further comprising
a power factor correction (PFC) converter having a plurality of legs in parallel with the DC link capacitor,
wherein the at least one processor is further configured to randomly select at least one of the plurality of legs, and turn on and off a switch included in the randomly selected at least one leg via the PWM switching signal.

6. The home appliance of claim 4, further comprising
a power factor correction (PFC) converter having a plurality of legs in parallel with the DC link capacitor,
wherein the at least one processor is further configured to sequentially select the plurality of legs, and turn on and off a switch included in at least one leg selected from among the plurality of legs via the PWM switching signal.

7. The home appliance of claim 1, wherein the determining, by the at least one processor, of the length of the non-conducting interval of the switch comprises performing, by the at least one processor, control to decrease the length of the non-conducting interval when the magnitude of the obtained harmonic component is greater than the predetermined harmonic reference value and increase the length of the non-conducting interval when the magnitude of the obtained harmonic component is less than the predetermined harmonic reference value.

8. The home appliance of claim 1, wherein
the obtained harmonic component is third-order, fifth-order, . . . , and Nth-order harmonics where N is an odd integer greater than or equal to 7, and
the determining, by the at least one processor, of the length of the non-conducting interval of the switch comprises
determining, by the at least one processor, a minimum value among an output of a third harmonic magnitude controller taking as an input a difference between the third-order harmonics and a third harmonic reference value, an output of a fifth harmonic magnitude controller taking as an input a difference between the fifth-order harmonics and a fifth harmonic reference value, . . . , and an output of an Nth harmonic magnitude controller taking as an input a difference between the Nth-order harmonics and an Nth harmonic reference value, and determining the length of the non-conducting interval based on the minimum value.

9. The home appliance of claim 1, wherein
the obtained harmonic component is a third-order harmonic component and an Nth-order harmonic component where N is an odd integer greater than or equal to 5, and
the determining, by the at least one processor, of the length of the non-conducting interval of the switch comprises,
when a magnitude of the Nth-order harmonic component is less than a predetermined Nth harmonic reference value, determining, by the at least one processor, the length of the non-conducting interval based on a result of subtracting a magnitude of the third-order harmonic component from a predetermined third harmonic reference value.

10. The home appliance of claim 1, wherein
the obtained harmonic component is the third-order harmonic component and the Nth-order harmonic component where N is an odd integer greater than or equal to 5, and
the determining, by the at least one processor, of the length of the non-conducting interval of the switch comprises,
when the magnitude of the Nth-order harmonic component is greater than the predetermined Nth harmonic reference value, subtracting, by the at least one processor, from the predetermined third harmonic reference value, an output of a controller that receives as an input a result of subtracting the magnitude of the Nth-order harmonic component from the predetermined Nth harmonic reference value, and
determining the length of the non-conducting interval based on a result of subtracting the magnitude of the third-order harmonic component from the third harmonic reference value that is the result of the subtraction.

11. The home appliance of claim 1, wherein the determining, by the at least one processor, of the length of the non-conducting interval of the switch comprises determining, by the at least one processor, the length of the non-conducting interval, based on an output value for controlling the magnitude of the obtained harmonic component to be less than the predetermined harmonic reference value and a phase difference between the input voltage and the input current of the power source.

12. The home appliance of claim 11, wherein the generating, by the at least one processor, of a current reference value corresponding to the determined length of the non-conducting interval comprises outputting, by the at least one processor, a current shape reference value corresponding to the current reference value, based on the determined length of the non-conducting interval and the phase difference between the input voltage and the input current of the power source.

13. The home appliance of claim 1, further comprising
an output current sensor configured to detect an output current supplied to a load, wherein the determining, by the at least one processor, of the length of the non-conducting interval of the switch comprises
determining, by the at least one processor, the length of the non-conducting interval based on a variation in the output current supplied to the load.

14. The home appliance of claim 1, wherein the at least one processor is further configured to perform control so that the magnitude of the obtained harmonic component is less than the predetermined harmonic reference value and the length of the non-conducting interval of the switch is maximized.

15. A method, performed by a home appliance, of controlling a harmonic magnitude,
the method comprising:
detecting, by a current sensor of the home appliance, an input current of a power source;
obtaining a harmonic component from the input current detected by the current sensor;
determining a length of a non-conducting interval of a switch so that a magnitude of the obtained harmonic component is less than a predetermined harmonic reference value; and
generating a current reference value corresponding to the determined length of the non-conducting interval.

16. An electrical appliance configured to operate with minimized operating losses, the home appliance comprising:
at least one harmonic extractor configured to extract magnitudes of harmonic components in real time from a power source including the electrical appliance;
a harmonic controller configured to control the extracted magnitudes of the harmonics to satisfy predetermined standard values, and to calculate a length of a non-conducting interval of a switch in a power factor correction (PFC) circuit; and
a pulse width modulation (PWM) generator configured to control the switch based on the non-conducting interval.

17. The electrical appliance of claim 16, wherein:
the harmonic controller determines that the extracted magnitudes do not satisfy the predetermined standard values in response to the extracted magnitudes exceeding the predetermined standard values.

18. The electrical appliance of claim 17, wherein calculating the length of the non-conducting value comprises:
calculating a control value that reduces the length of the non-conducting interval in response to the extracted magnitudes not satisfying the predetermined standard values; and
calculating a control value that increases the length of a non-conducting interval in response to the extracted magnitudes satisfying the predetermined standard values.

19. The electrical appliance of claim 18, further comprising a current controller configured to generate a current reference value corresponding to the length of the non-conducting interval.

20. The electrical appliance of claim 19, wherein the PWM generator is configured to generate a PWM switching signal that controls the switch based at least in part on the current reference value.
